(19) United States
(12) Patent Application Publication
(10) Pub. No.: US 2010/0284372 A1
(43) Pub. Date: Nov. 11, 2010

(54) APPARATUS, METHOD AND COMPUTER PROGRAM PRODUCT PROVIDING AVOIDANCE OF DATA DUPLICATION DURING PACKET SWITCHED HANDOVER

(75) Inventors: Iuliana Marinescu, Espoo (FI); Vlora Rexhepi, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/519,632

(22) PCT Filed: Dec. 17, 2007
(86) PCT No.: PCT/IB07/03969

§ 371 Date: May 5, 2010

(30) Foreign Application Priority Data
Dec. 18, 2006 (US) 60875643

(51) Int. Cl. H04W 36/00

(52) U.S. Cl. 370/332

(57) ABSTRACT

A method for handling PDUs in a handover is described. The method includes receiving a PDU from a network element. The PDU is transmitted in conjunction with an indicator to a MS. The indicator indicates whether the MS is required to check if the transmitted PDU is a duplicate of a previously transmitted PDU. The method also includes receiving a PDU from the network element. There is a determination made of whether a check of the received PDU is required. If the check is required a determination of whether the received PDU is a duplicate of a previously received PDU is made. If the received PDU is a duplicate it is discarded. If the received PDU is not a duplicate the received PDU is forwarded for processing. An apparatus is also described.

### TECHNICAL FIELD

The exemplary and non-limiting embodiments of this invention relate generally to wireless communication systems, methods, devices and computer program products and, more specifically, relate to procedures performed when handing over a mobile device from one cell to another cell.

### BACKGROUND

Various abbreviations found in the specification and drawings are defined as follows:
3GPP third generation partnership project
aGW access gateway
BSS base station subsystem
CN core network
DL downlink (base station subsystem to mobile station)
eNB E-UTRAN Node-B
E-UTRAN evolved UMTS terrestrial radio access network
Gb BSS-SGSN interface
GERAN GSM EDGE radio access network
GGSN gateway GPRS support node
Gn SGSN-GGSN interface
GPRS general packet radio system
HO handover
LLC logical link control
LTE long term evolution
MS mobile station
Node-B base station
PDP packet data protocol
PDU protocol data unit
PS packet switched
QoS quality of service
RAT radio access technology
RNC radio network controller
SGSN serving GPRS support node
SN sequence number
UL uplink (mobile station to base station subsystem)
Um MS-BSS interface
UMTS universal mobile terrestrial system
UTRAN UMTS terrestrial radio access network

Minimizing service interruption during a cell/routing area/tracking area change is an important requirement in handover procedures already specified for packet switched services, as well as in those currently being specified in 3GPP.

Reduced service interruption on the DL transfer is enabled by packet forwarding from network nodes between the old cell (the currently serving cell) and the new cell (the target cell) before the handover is completed.

In GPRS and E-GPRS, during a routing area change the new SGSN forwards downlink packets to the BSS in the target cell. The BSS in the target cell that may then begin a blind transmission of downlink user data towards the MS over the allocated radio channels. This type of blind transmission implies a duplication of received packets in the MS during an inter-SGSN PS Handover procedure. Removing the duplicated data packets requires processing in the MS at the application layer, which in turn results in increased memory requirements and increased battery power consumption.

Packet forwarding is currently performed in certain systems, e.g., see: 3GPP TS 23.060 V7.2.0 (2006-Sep.), Technical Specification, 3rd Generation Partnership Project; Technical Specification Group Services and System Aspects; General Packet Radio Service (GPRS); Service description; Stage 2 (Release 7); 3GPP TS 25.401 V7.1.0 (2006-Sep.), Technical Specification, 3rd Generation Partnership Project; Technical Specification Group Radio Access Network; UTRAN overall description (Release 7); and 3GPP TS 25.413 V7.3.0 (2006-Sep.), Technical Specification, 3rd Generation Partnership Project; Technical Specification Group Radio Access Network; UTRAN Iu interface RANAP signalling (Release 7); and it is the selected mechanism in the currently ongoing specification for E-UTRAN as well, e.g., see: 3GPP TR 25.912 V7.1.0 (2006-Sep.), Technical Report, 3rd Generation Partnership Project; Technical Specification Group Radio Access Network; Feasibility study for evolved Universal Terrestrial Radio Access (UTRA) and Universal Terrestrial Radio Access Network (UTRAN) (Release 7); and 3GPP TR R3.018 V0.1.0 (2006-Jan.), Technical Report, 3rd Generation Partnership Project; Technical Specification Group Radio Access Network; Evolved UTRA and UTRAN; Radio Access Architecture and Interfaces (Release 7).

More specifically, the packet forwarding from the CN node in the old cell to the CN node in the new cell during handover begins at the moment when the CN node receives an indication that the CN node in the new cell is ready to receive packets from the CN node in the old cell. As the forwarding of the packets begins prior to the MS actually moving to the new cell, if the new CN node forwards these packets to the radio access nodes of the new cell, the MS will receive duplicates of the packet data units in the new cell. As was noted above, removing the duplicated data packets requires processing in the MS at the application layer, which in turn results in increased memory requirements and increased battery power consumption.

With regard to a specific problem in GPRS, EGPRS, during the inter-SGSN PS handover described in 3GPP TS 43.129 V6.9.0 (2006-Sep.), Technical Specification, 3rd Generation Partnership Project; Technical Specification Group GERAN; Packet-switched handover for GERAN A/Gb mode; Stage 2 (Release 6), and referring to FIG. 1, the new SGSN may, for PDP context(s) which use LLC ADM based on QoS, proceed with the packet handling by either: (a) forwarding the received downlink N-PDUs to the target BSS; (b) store the received data into the SNDCP queue for, e.g., the PDU lifetime; or (c) discard the received data until, for example, the reception of a PS Handover Complete message.

In the case where the new SGSN forwards the received DL N-PDUs to the target BSS, and target BSS utilizes blind transmission to the cell, there will be data duplication in the MS (see FIG. 2).

The problem of data duplication, and buffering at network nodes as a solution of avoiding data duplication, was discussed at least in 3GPP TSG RAN2#56, R2-063138, Riga, Latvia, 6-10 Nov. 2006, Source: NEC, Title: Lossless/Seamless Intra-LTE Handover, Agenda Item: 11.6.1.

### SUMMARY

An exemplary embodiment of this invention is a method for handling PDUs in a HO. The method includes receiving a PDU from a network element. There is a determination made of whether a check of the received PDU is required. If the check is required a determination of whether the received PDU is a duplicate of a previously received PDU is made. If he received PDU is a duplicate it is discarded. If the received PDU is not a duplicate the received PDU is forwarded for processing.

A further exemplary embodiment of this invention is a method for handling PDUs in a HO. The method includes receiving a PDU from a network element. The PDU is transmitted in conjunction with an indicator to a MS. The indicator indicates whether the MS is required to check if the transmitted PDU is a duplicate of a previously transmitted PDU.

Another exemplary embodiment of this invention is an apparatus for handling PDUs in a HO. The apparatus includes a receiver to receive a PDU from a network element. A processing unit determines whether a check of the received PDU is required. If the check is required, the processing unit determines whether the received PDU is a duplicate of a previously received PDU. If the received PDU is a duplicate, the processing unit discards the received PDU. If the received PDU is not a duplicate, a forwarding forwards the received PDU for processing.

A further exemplary embodiment of this invention is an apparatus for handling PDUs in a HO. The apparatus includes a receiver to receive a PDU from a network element. A transmitter can transmit the PDU in conjunction with an indicator to a MS. The indicator indicates whether the MS is required to check if the transmitted PDU is a duplicate of a previously transmitted PDU.

Another exemplary embodiment of this invention is an apparatus for handling PDUs in a HO. The apparatus includes receiving means for receiving a PDU from a network element. A check determining means determines whether a check of the received PDU is required. If the check is required, a duplicate determining means determines whether the received PDU is a duplicate of a previously received PDU. If the received PDU is a duplicate, a discarding means discards the received PDU. If the received PDU is not a duplicate, a forwarding means forwards the received PDU for processing.

A further exemplary embodiment of this invention is an apparatus for handling PDUs in a HO. The apparatus includes a means for receiving a PDU from a network element. A means for transmitting can transmit the PDU in conjunction with an indicator to a MS. The indicator indicates whether the MS is required to check if the transmitted PDU is a duplicate of a previously transmitted PDU.

Another exemplary embodiment of this invention is a method for handling PDUs in a HO. The method includes receiving a PDU from a network element. The method also includes determining whether a timer has elapsed. If the timer has not elapsed the PDU is discarded. If the timer has elapsed, the PDU is transmitted to a MS.

A further exemplary embodiment of this invention is an apparatus for handling PDUs in a HO. The apparatus includes a receiver that can receive a PDU from a network element. A timer is also part of the apparatus. A data processing unit can determine whether the timer has elapsed. If the timer has not elapsed the data processing unit discards the PDU. If the timer has elapsed, a transmitter transmits the PDU to a MS.

Another exemplary embodiment of this invention is an apparatus for handling PDUs in a HO. The apparatus includes a means for receiving that can receive a PDU from a network element. A timer means is also part of the apparatus. A determining means can determine whether the timer means has elapsed. If the timer means has not elapsed a means for discarding discards the PDU. If the timer means has elapsed, a means for transmitting transmits the PDU to a MS.

### BRIEF DESCRIPTION OF THE DRAWINGS

In the attached Drawing Figures:

FIG. 1 presents an Inter-BSS Inter-SGSN PS Handover as described in 3GPP TS 43.129.

FIG. 2 presents an example of a problem created in the case of the Inter-BSS Inter-SGSN PS Handover.

FIG. 3 shows a simplified block diagram of various electronic devices that are suitable for use in practicing the exemplary embodiments of this invention.

FIG. 4 is a logic flow diagram in accordance with an exemplary embodiment of this invention.

FIG. 5 is a logic flow diagram in accordance with another exemplary embodiment of this invention.

FIG. 6 illustrates an exemplary user plane protocol structure.

### DETAILED DESCRIPTION

The exemplary embodiments of this invention provide mechanisms for avoiding data duplication in the MS during handover of packet switched services in cellular systems standardized and currently undergoing standardization in 3GPP.

The exemplary embodiments of this invention provide techniques to remove data packet duplicates in the network prior to sending them to the MS, as well as at the MS lower protocol layer(s) prior to forwarding received packets to upper protocol layers.

It is noted that the exemplary embodiments of this invention will be described below in the context of the GERAN A/Gb mode between source and target network nodes. However, use of the exemplary embodiments of this invention is applicable to other types of systems as well, such as UTRAN and E-UTRAN intra-RAT and inter-RAT handovers, when the packet forwarding and blind transmission is utilized. As such, the exemplary embodiments of this invention are not intended to be limited for use with any one type of radio access technology, or with any one particular type of radio access standard.

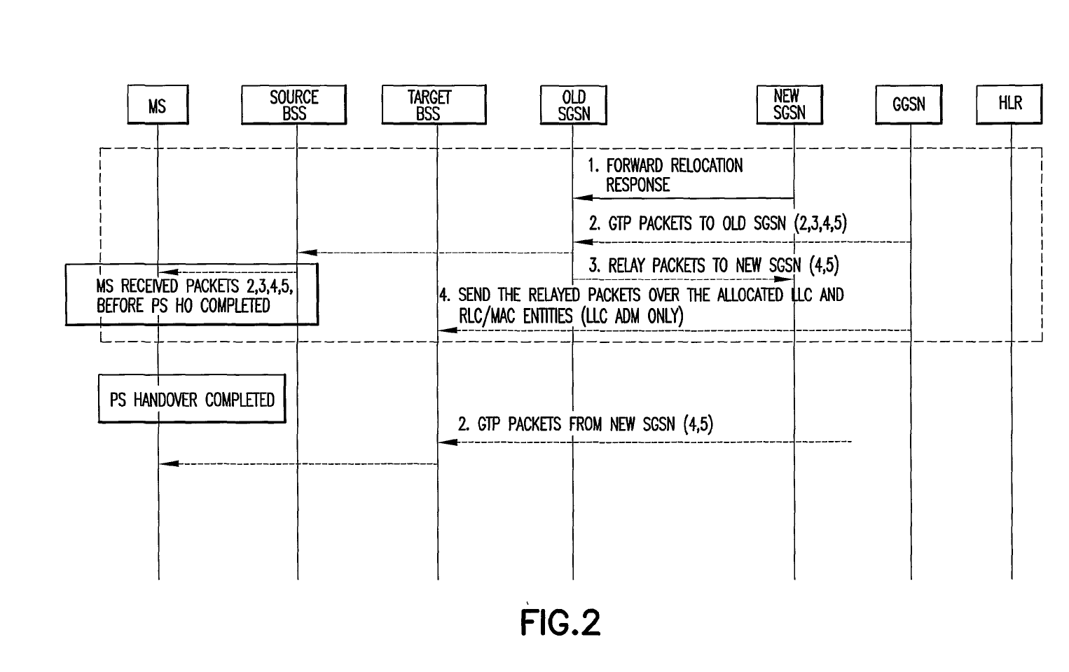

Reference is made to FIG. 3 for illustrating a simplified block diagram of various electronic devices that are suitable for use in practicing the exemplary embodiments of this invention. In FIG. 3 a wireless network is adapted for communication with a MS 10 via at least one BSS (base station) 12. The network includes at least one SGSN 14 coupled to the BSS 12 via a Gb interface 13. The MS 10 includes a data processor (DP) 10A, a memory (MEM) 10B that stores a program (PROG) 10C, and a suitable radio frequency (RF) transceiver 10D for bidirectional wireless communications with the BSS 12, which also includes a DP 12A, a MEM 12B that stores a PROG 12C, and a suitable RF transceiver 12D. The SGSN 14 also includes at least one DP 14A and a MEM 14B storing an associated PROG 14C. At least the PROGs 10C and 14C are assumed to include program instructions that, when executed by the associated DPs 10A and 14A, enable the MS 10 and the SGSN 14 to operate in accordance with the exemplary embodiments of this invention, as will be discussed below in greater detail.

Shown for completeness in FIG. 3 is at least one second BSS 12, referred to as 12′ that in turn is coupled to a second SGSN 14, referred to as 14′. The SGSN 14 and SGSN 14′ are coupled via a Gn interface 15 to a GGSN 16 that, along with a HLR 18, may be considered to form a part of the CN 20.

During a HO event the BSS 12 may be considered the Source BSS, i.e., the BSS (the ‘old’ BSS) to which the MS 10 is currently connected and communicating in the associated serving cell, and the BSS 12′ may be considered the Target BSS, i.e., the BSS to which the UE 10 is to be connected and communicating with (the ‘new’ BSS) in the target cell after the HO procedure is completed. Note that in practice the serving cell and the target cell may at least partially overlap one another.

It should be appreciated that the exemplary embodiments of this invention may be implemented at least in part by computer software executable by the DPs 14A of the SGSNs 14, or by hardware, or by a combination of software and hardware.

In general, the various embodiments of the MS 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

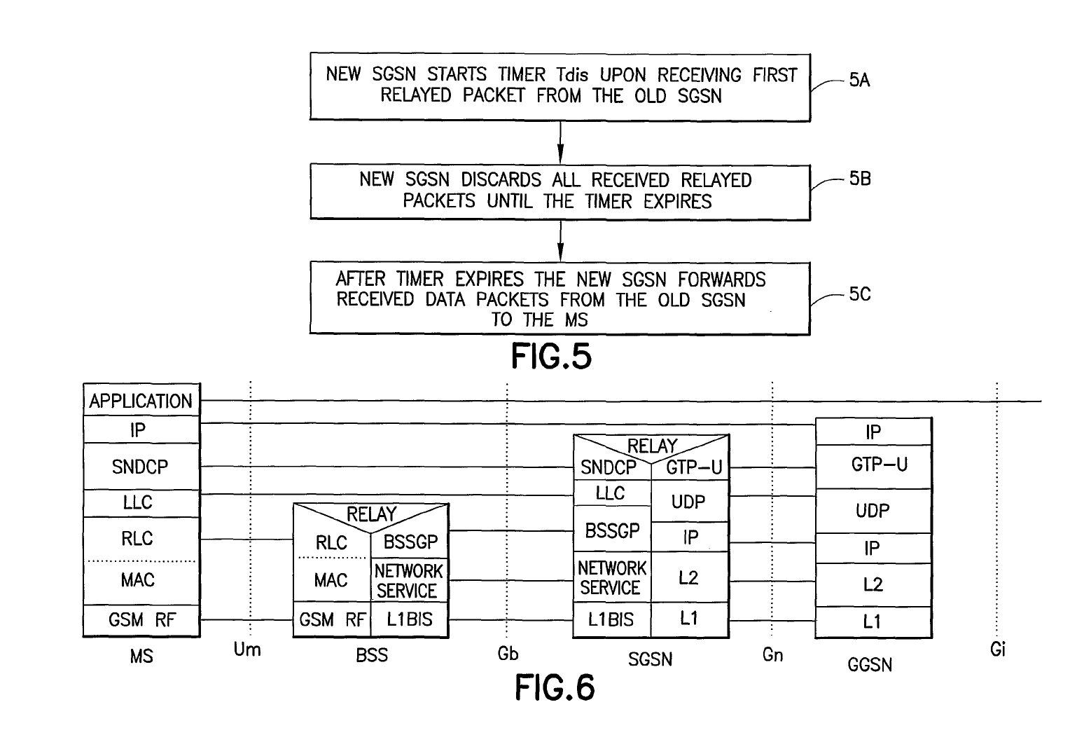

Reference is made to FIG. 6 which illustrates an exemplary user plane protocol structure. The protocol structure shown is a user plane protocol architecture for GERAN A/Gb mode and is a non-limiting example.

One goal of the exemplary embodiments of this invention mechanism is to avoid the processing of duplicated packet data in the MS 10 and, preferably, to avoid the processing of duplicate packets at the higher (e.g., application layers) in the MS 10. The processing of the duplicated packet data can be avoided by removing these packet data units either in the network nodes or by the MS 10 before they are forwarded to the higher layer for processing.

The CN node (SGSN 14) in the old cell, upon an indication of a successful PS handover, starts to forward packet data to the CN node in the new cell. The CN node (SGSN 14′) in the new cell, depending on the QoS and its own internal policies on services and packet data handling, may decide to:
in a first exemplary embodiment, forward the packets to the MS 10 by indicating that these are relayed PDUs from the old CN node; or
in a second exemplary embodiment, discard the packets for some certain period of time, for example, for at least the amount of time required for the MS 10 to access the new cell. In this case the old CN node then begins to forward the remainder of the packets until it receives an indication of the completion of the handover.

In the first exemplary embodiment an identifier (ID) is added to the PDU header of the data sent to MS 10, together with the SN as received from the CN node in the old cell, to indicate that this is a relayed PDU. Based on the identifier the MS 10 identifies the PDU as a relayed PDU and, based on the received sequence number, it can determine whether this PDU has been previously received prior to forwarding it to the higher layers. In this manner a duplicate PDU can be discarded by the MS 10, i.e., not forwarded to the higher protocol layers.

In the second embodiment a timer 14D is included in the CN node (SGSN 14′) which is set to the time needed for the access of the MS 10 in the new cell. The CN node discards the relayed data packets until the timer 14D expires, after which it forwards the remainder of the relayed packet data.

These exemplary embodiments are clearly applicable to 3GPP systems where PS handover and data forwarding are enabled.

In the ensuing description the implementation of the foregoing embodiments in GPRS, EGPRS is described, although it is again noted that the embodiments of this invention are not limited for use with only GPRS, EGPRS.

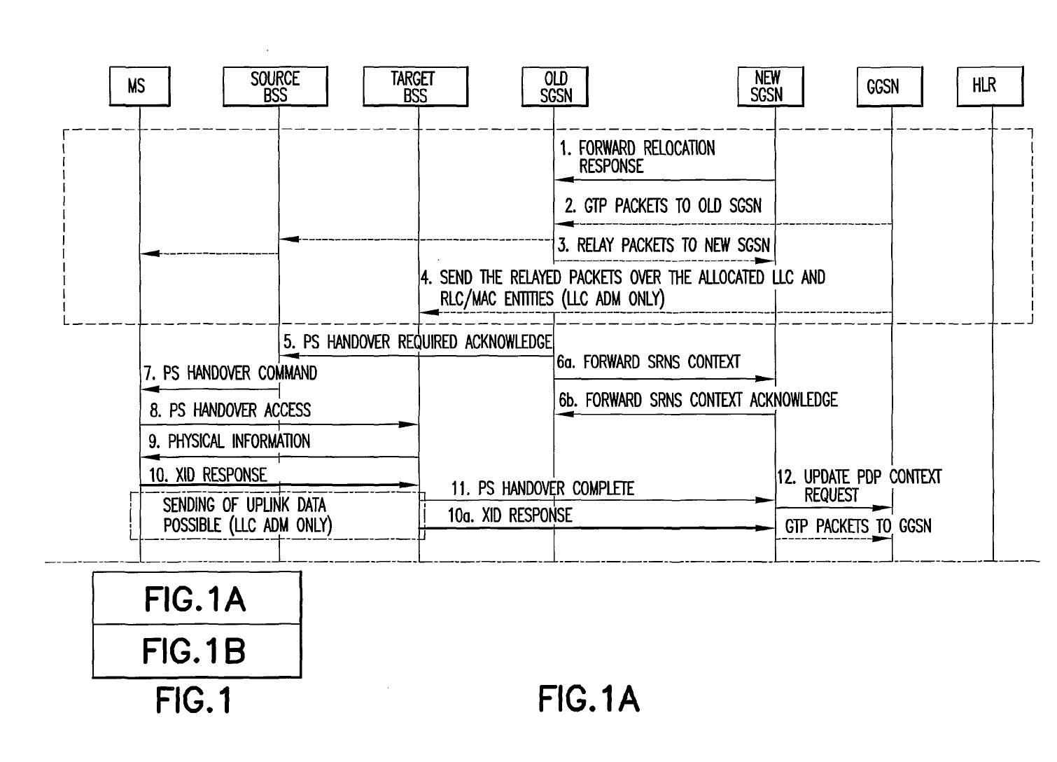

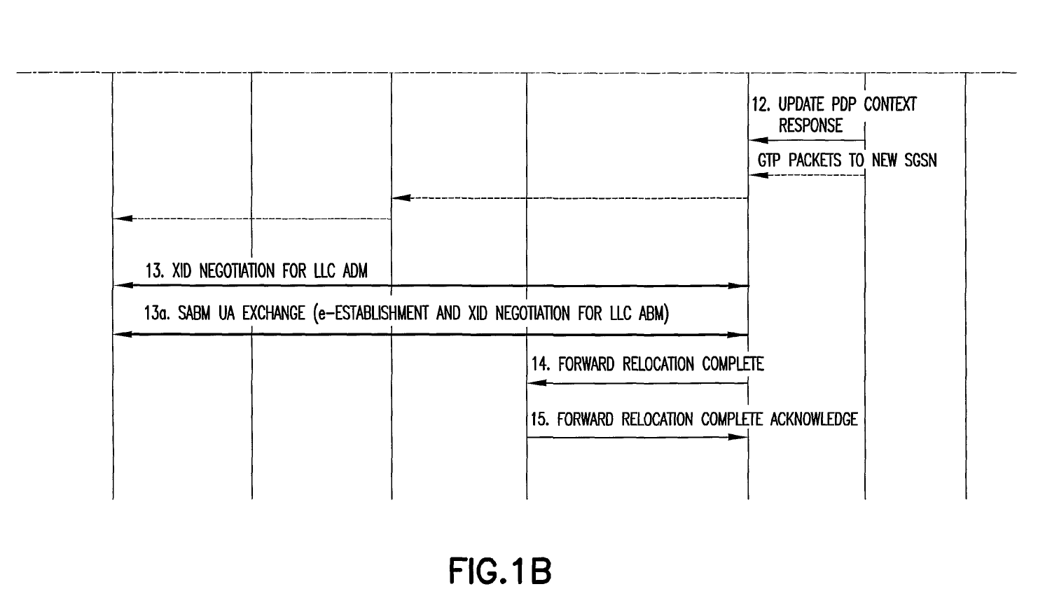

As described in 3GPP TS 43.129, the old SGSN 14 receives a Forward Relocation Response message from the new SGSN 14′ (see also FIGS. 1 and 2). The old SGSN 14 sends data packets to the MS 10 as well as to the new SGSN 14′, and the new SGSN 14′ may forward the data packets to the radio network which in turn will blindly transmit the data packets into the new cell. As a result, the MS 10 can receive duplicate data packets.

Embodiment 1

The old SGSN 14 sends a Send N-PDU number for each relayed packet to the new SGSN 14′. The new SGSN 14′ indicates (flags) to the MS 10 that a current packet is a relayed packet and sends the same Send N-PDU number to the MS 10. The MS 10 receiving the flagged PDU will check the Send N-PDU number to determine whether it has received this packet or not. If it has already received the PDU it discards it. If not, it forwards it to a higher protocol level for further processing. In this embodiment the MS 10 temporarily stores in the memory 10 the Send_N-PDU number of at least the last received PDU so that it can compare same to determine if a subsequently received PDU is a duplicate PDU.

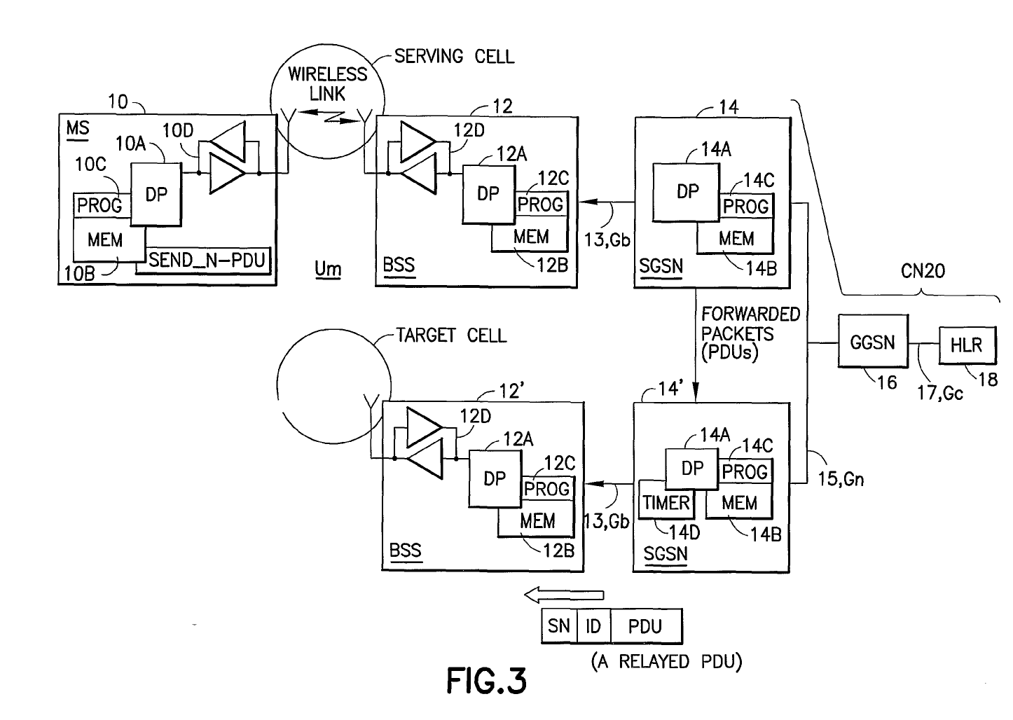

Referring to FIG. 4, in accordance with a method, and the operation of corresponding computer programs products, the following operations are performed.

Block 4A: the new SGSN 14′ indicates with a Flag to the MS 10 to check the PDU header for the Send_N-PDU number.

Block 4B: if the Flag set to ‘check’ the MS 10 compares the value of the received Send_N-PDU to the value of the stored Send_N-PDU.

Block 4C: If the Send_N-PDU value equals the previous received Send_N-PDU value in the MS 10, the MS 10 discards the PDU.

Block 4D: If the Send_N-PDU value does not equal the previous received Send_N-PDU value in the MS 10, the MS 10 forwards the data packet to a higher protocol layer for processing.

Block 4E: After the PS Handover is completed and the SGSN 14′ has sent all of the relayed packets to the MS 10, the SGSN 14′ sets the Flag to a ‘do not check’ state for all subsequent PDUs received from the GGSN 16. The MS 10 subsequently does not perform any checks with the Send N-PDU number, and it may reset the received Send_N-PDU number.

It is noted that currently the Send N-PDU number is sent as part of the GTP-PDU (3GPP TS 29.060) and SN PDU (see 3GPP TS 44.065, V7.0.0 (2006-Sep.), Technical Specification 3rd Generation Partnership Project; Technical Specification Group Core Network and Terminals; Mobile Station (MS)—Serving GPRS Support Node (SGSN); Subnetwork Dependent Convergence Protocol (SNDCP) (Release 7)) only in the case of the LLC acknowledged mode. In this exemplary embodiment of the invention the Send_N-PDU number is also sent in the case of the LLC unacknowledged mode.

There is a Spare bit (X): in the SN PDU header that may be used as the Flag indicator, or a new field may be specified in 3GPP TS 44.065. Currently the Spare bit (X) is set to 0 by the transmitting SNDCP entity and is ignored by the receiving SNDCP entity.

Embodiment 2

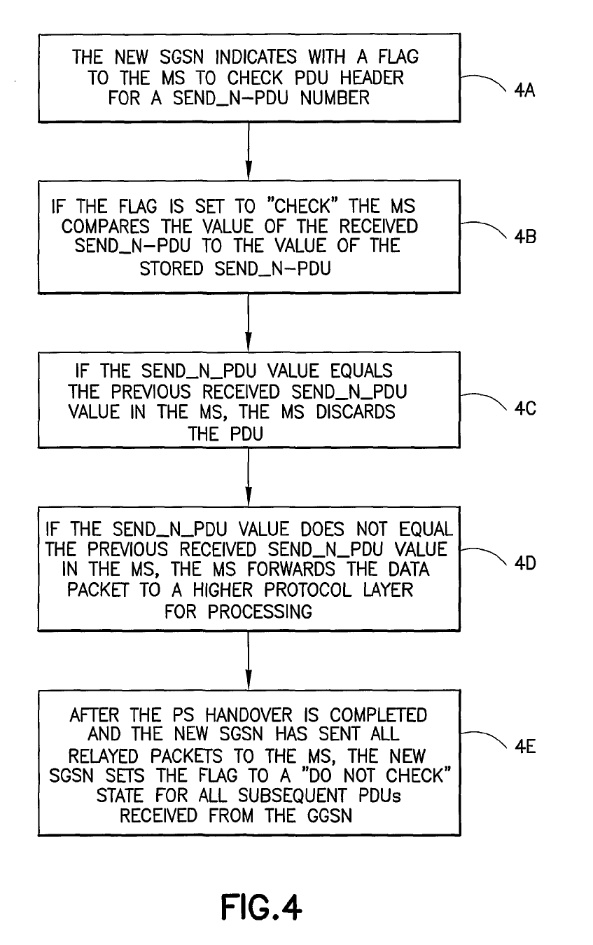

In this embodiment the timer 14D (Tdis) is defined in the SGSN 14′ (actually in all embodiments of the SGSN 14, 14′) for discarding relayed packets. Referring to FIG. 5, at Block 5A the new SGSN 14′ starts the timer 14D upon receiving the first relayed packet from the old SGSN 14, and at Block 5B the new SGSN 14′ discards all received relayed packets until the timer 14D expires. The value of the Tdis is set to be equal to the time required for the MS 10 to access the new cell. At Block 5C, and after the expiry of the timer 14D, the SGSN 14′ forwards the received data packets from the old SGSN 14 to the MS 10, such as is described in 3GPP TS 43.129.

By the use of the timer 14D the MS 10 may still receive duplicated data, but the amount of duplicated data will be reduced as compared to not using the timer 14D at all.

Note that this second embodiment does not require that any modification be made to the MS 10.

It should be noted that the two embodiments need not be used in isolation, and that they may be used together such that data packet duplicates are primarily removed in the network, through the use of the timer 14D in the SGSN 14′, while any remaining ones are removed at the MS 10 through the use of the duplicate flag.

It should be appreciated that the embodiments of this invention provide a method, an apparatus and a computer programs product to operate a network node to which a MS will be handed over to instruct the MS to compare an identifier of a PDU being sent to an identifier of a previously received PDU to determine if the PDU being sent is a duplicate of the previously received PDU.

It should be further appreciated that the embodiments of this invention provide a method, an apparatus and a computer programs product to operate a MS during handover to be responsive to a flag set in a PDU by a network node to compare an identifier of a received PDU to an identifier of a previously received PDU to determine if the received PDU is a duplicate of the previously received PDU. If the received PDU is a duplicate of the previously received PDU, the MS discards the received PDU, otherwise it forwards it for further processing.

This method includes storing in the MS the identifier of a received PDU for comparison with an identifier of a subsequently received PDU, when so instructed to do so by the network node.

It should be further appreciated that the embodiments of this invention provide a method, an apparatus and a computer programs product to operate a network node to which a MS will be handed over to initialize operation of a timer upon receiving a first relayed (forwarded) packet from a network node that is currently serving the MS, to discard all received relayed packets until the timer expires, and to then begin forwarding relayed packets to the MS. The timer may be initialized so as to expire after a time required for the MS to access a new cell served by the network node.

In the previously described methods the network node may be a SGSN.

Note that in general, the various blocks shown in, FIGS. 4 and 5 may be viewed as method steps, and/or as operations that result from operation of computer program code, and/or as a plurality of coupled logic circuit elements constructed to carry out the associated function(s).

An exemplary embodiment of this invention is a method for handling PDUs in a HO. The method includes receiving a PDU from a network element. There is a determination made of whether a check of the received PDU is required. If the check is required a determination of whether the received PDU is a duplicate of a previously received PDU is made. If he received PDU is a duplicate it is discarded. If the received PDU is not a duplicate the received PDU is forwarded for processing.

In a further embodiment of the method above, the determination of whether a check of the received PDU is required includes receiving an indicator from the network element indicating whether the check is required. The indicator may be a flag set in a PDU header.

In another embodiment of any of the methods above, the determination of whether the received PDU is a duplicate of the previously received PDU includes comparing a SN of the previously received PDU to a SN of the received PDU.

In a further embodiment of any of the methods above, the previously received protocol data unit was received from a source network element of a handover of a mobile station and the received protocol data unit is received from the target network element.

In a further embodiment of any of the methods above, the network element is part of a SGSN.

In another embodiment of any of the methods above, the method is performed as a result of execution (e.g., by a data processor) of computer program instructions stored in a computer readable memory medium.

A further exemplary embodiment of this invention is a method for handling PDUs in a HO. The method includes receiving a PDU from a network element. The PDU is transmitted in conjunction with an indicator to a MS. The indicator indicates whether the MS is required to check if the transmitted PDU is a duplicate of a previously transmitted PDU.

In another embodiment of the methods above, the indicator is a flag set in a PDU header.

In a further embodiment of any of the methods above, the method also includes transmitting a SN of the transmitted PDU to the MS.

In another embodiment of any of the methods above, the protocol data unit was received from a source network element of a handover of the mobile station.

In a further embodiment of any of the methods above, the network element is part of a SGSN.

In another embodiment of any of the methods above, the PDU is received following a successful packet switched HO of the MS from the network element.

In a further embodiment of any of the methods above, the method includes determining whether a timer has elapsed. If the timer has not elapsed the PDU is discarded. The transmitting of the PDU in conjunction with the indicator occurs if the timer has elapsed. The timer may be started in response to a successful HO of the MS from the network element.

In another embodiment of any of the methods above, the method is performed as a result of execution (e.g., by a data processor) of computer program instructions stored in a computer readable memory medium.

A further exemplary embodiment of this invention is an apparatus for handling PDUs in a HO. The apparatus includes a receiver to receive a PDU from a network element. A processing unit determines whether a check of the received PDU is required. If the check is required, the processing unit determines whether the received PDU is a duplicate of a previously received PDU. If the received PDU is a duplicate, the processing unit discards the received PDU. If the received PDU is not a duplicate, a forwarding forwards the received PDU for processing.

In another embodiment of the apparatus above, the receiver can receive an indicator from the network element indicating whether the check is required. The indicator may be a flag set in a PDU header.

In a further embodiment of any of the apparatuses above, the determination of whether the received PDU is a duplicate of the previously received PDU includes comparing a SN of the previously received PDU to a SN of the received PDU.

A further exemplary embodiment of this invention is an apparatus for handling PDUs ill a HO. The apparatus includes a receiver to receive a PDU from a network element. A transmitter can transmit the PDU in conjunction with an indicator to a MS. The indicator indicates whether the MS is required to check if the transmitted PDU is a duplicate of a previously transmitted PDU.

In another embodiment of the apparatus above, the indicator is a flag set in a PDU header.

In a further embodiment of any of the apparatuses above, the transmitter can transmit a SN of the transmitted PDU to the MS.

In another embodiment of any of the apparatuses above, the network element is part of a SGSN.

In a further embodiment of any of the apparatuses above, the apparatus includes a timer. A processing unit can determine whether a timer has elapsed. If the timer has not elapsed the PDU is discarded. The transmitting of the PDU in conjunction with the indicator occurs if the timer has elapsed. The timer may be started in response to a successful HO of the MS from the network element.

A further exemplary embodiment of this invention is an apparatus for handling PDUs in a HO. The apparatus includes receiving means for receiving a PDU from a network element. A check determining means determines whether a check of the received PDU is required. If the check is required, a duplicate determining means determines whether the received PDU is a duplicate of a previously received PDU. If the received PDU is a duplicate, a discarding means discards the received PDU. If the received PDU is not a duplicate, a forwarding means forwards the received PDU for processing.

A further exemplary embodiment of this invention is an apparatus for handling PDUs in a HO. The apparatus includes a means for receiving a PDU from a network element. A means for transmitting can transmit the PDU in conjunction with an indicator to a MS. The indicator indicates whether the MS is required to check if the transmitted PDU is a duplicate of a previously transmitted PDU.

Another exemplary embodiment of this invention is a method for handling PDUs in a HO. The method includes receiving a PDU from a network element. The method also includes determining whether a timer has elapsed. If the timer has not elapsed the PDU is discarded. If the timer has elapsed, the PDU is transmitted to a MS.

In a further embodiment of the method above, the timer is started following a successful HO of the MS from the network element. The expiration of the timer may indicate at least an amount of time required for the MS to access a new cell.

In another embodiment of the methods above, the network element is part of a SGSN.

In a further embodiment of any of the methods above, the HO is a packet switched HO.

In another embodiment of any of the methods above, the method is performed as a result of execution (e.g., by a data processor) of computer program instructions stored in a computer readable memory medium.

A further exemplary embodiment of this invention is an apparatus for handling PDUs in a HO. The apparatus includes a receiver that can receive a PDU from a network element. A timer is also part of the apparatus. A data processing unit can determine whether the timer has elapsed. If the timer has not elapsed the data processing unit discards the PDU. If the timer has elapsed, a transmitter transmits the PDU to a MS.

In another embodiment of the apparatus above, the tinier is started following a successful HO of the MS from the network element. The expiration of the timer may indicate at least an amount of time required for the MS to access a new cell.

In a further embodiment of any of the apparatuses above, the HO is a packet switched HO.

A further exemplary embodiment of this invention is an apparatus for handling PDUs in a HO. The apparatus includes a means for receiving that can receive a PDU from a network element. A timer means is also part of the apparatus. A determining means can determine whether the timer means has elapsed. If the timer means has not elapsed a means for discarding discards the PDU. If the tinier means has elapsed, a means for transmitting transmits the PDU to a MS.

In general, the various exemplary embodiments may be implemented in hardware or special purpose circuits, software, logic or any combination thereof For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while described above in the context of BSSs, SGSNs and a GGSN, the exemplary embodiments of this invention may be practiced in other types of systems using different network elements, such as in an E-UTRAN system using Node-Bs (eNBs), RNCs and an aGW, as one non-limiting example.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
receiving a protocol data unit from a network element;
receiving an indicator from the network element indicating whether a check of the received protocol data unit is required, wherein the indicator comprises a flag set in a protocol data unit header:
determining whether the check of the received protocol data unit is required based on the received indicator;
in response to determining that the check is required, determining whether the received protocol data unit is a duplicate of a previously received protocol data unit;
in response to determining that the received protocol data unit is a duplicate, discarding the received protocol data unit; and
in response to determining that the received protocol data unit is not a duplicate, forwarding the received protocol data unit for processing.

2-42. (canceled)

43. The method according to claim 1, wherein determining whether the received protocol data unit is a duplicate of the previously received protocol data unit comprises:
comparing a sequence number of the previously received protocol data unit to a sequence number of the received protocol data unit.

44. The method according to claim 1, wherein the previously received protocol data unit was received from a source network element of a handover of a mobile station and the received protocol data unit is received from a target network element of the handover.

45. The method according to claim 1, wherein the network element comprises a serving general packet radio system support node.

46. The method according to claim 1, performed as a result of execution of computer program instructions stored in a computer readable memory medium.

47. A method comprising:
receiving a protocol data unit from a network element; and
transmitting to a mobile station the protocol data unit in conjunction with an indicator indicating whether the mobile station is required to check whether the transmitted protocol data unit is a duplicate of a previously transmitted protocol data unit, wherein the indicator comprises a flag set in a protocol data unit header.

48. The method according to claim 6, further comprising transmitting a sequence number of the transmitted protocol data unit to the mobile station.

49. The method according to claim 6, wherein the protocol data unit was received from a source network element of a handover of the mobile station.

50. The method according to claim 6, wherein the network element is a serving general packet radio system support node.

51. The method according to claim 6, wherein the protocol data unit is received following a successful packet switched handover of the mobile station from the network element.

52. The method according to claim 6, further comprising:
determining whether a timer has elapsed; and
in response to determining the timer has not elapsed, discarding the protocol data unit;
in response to determining the timer has elapsed, transmitting the protocol data unit in conjunction with the indicator.

53. The method according to claim 11, further comprising in response to a successful handover of the mobile station from the network element, starting the timer.

54. The method according to claim 6, performed as a result of execution of computer program instructions stored in a computer readable memory medium.

55. An apparatus comprising:
a receiver configured to receive a protocol data unit from a network element and to receive an indicator from the network element indicating whether a check of the received protocol data unit is required, wherein the indicator comprises a flag set in a protocol data unit header;
a processor configured to determine whether the check of the received protocol data unit is required based on the received indicator;
wherein the processor is configured to, in response to determining that the check is required, determine whether the received protocol data unit is a duplicate of a previously received protocol data unit, wherein the processor is configured to, in response to determining that the received protocol data unit is a duplicate, discard the received protocol data unit, and wherein the processor is configured to, in response to determining that the received protocol data unit is not a duplicate, forward the received protocol data unit for processing.

56. The apparatus according to claim 14, wherein the processor is further configured to compare a sequence number of the previously received protocol data unit to a sequence number of the received protocol data unit when determining whether the received protocol data unit is a duplicate.

57. An apparatus comprising:
a receiver configured to receive a protocol data unit from a network element; and
a transmitter configured to transmit to a mobile station the protocol data unit in conjunction with an indicator indicating whether the mobile station is required to check whether the transmitted protocol data unit is a duplicate of a previously transmitted protocol data unit, wherein the indicator comprises a flag set in a protocol data unit header.

58. The apparatus according to claim 16, wherein the transmitter is further configured to transmit a sequence number of the transmitted protocol data unit to the mobile station.

59. The apparatus according to claim 16, wherein the network element is a serving general packet radio system support node.

60. The apparatus according to claim 16, further comprising:
a timer; and
a processor configured to determine whether a timer has elapsed and in response to determining the timer has not elapsed; to discard the protocol data unit;
wherein the transmitter is further configured to transmit the protocol data unit in conjunction with the indicator in response to determining that the timer has elapsed.

61. The apparatus according to claim 19, wherein the timer is configured to start in response to a successful handover of the mobile station from the network element.
